(19) United States
(12) Patent Application Publication
(10) Pub. No.: US 2020/0172109 A1
(43) Pub. Date: Jun. 4, 2020

(54) VEHICLE HAVING ELECTRIC MOTOR AND DRIVING CONTROL METHOD FOR THE SAME

(71) Applicants: Hyundai Motor Company, Seoul (KR); Kia Motors Corporation, Seoul (KR)

(72) Inventors: Hui Un Son, Suwon (KR); Sung Bae Jeon, Ansan (KR); Joon Young Park, Seoul (KR); Jin Kyeom Cho, Suwon (KR)

(21) Appl. No.: 16/579,226

(22) Filed: Sep. 23, 2019

(30) Foreign Application Priority Data
Dec. 3, 2018 (KR) 10-2018-0153767

(51) Int. Cl. B60W 40/064; B60L 7/18; B60W 30/18; B60W 40/072

(52) U.S. Cl. CPC B60W 40/064; B60L 7/18; B60W 2040/1307; B60W 40/072; B60W 30/18127

(57) ABSTRACT

A vehicle having an electric motor and a driving control method for the same are provided. The method of controlling regenerative braking torque of a motor of a vehicle, which is configured to transmit power of the motor to opposite side wheels via a differential gear, includes determining whether a curved road is present ahead of the vehicle. When the curved road is detected, the load to be applied to an inner wheel of the opposite side wheels is determined depending on lateral weight shifting on the curved road based on at least one of the curvature of the curved road or the vehicle speed. A grip of the inner wheel is determined based on the determined load and a regenerative braking limit is corrected based on the determined grip.

### CROSS REFERENCE TO RELATED APPLICATION(S)

This application claims the benefit of Korean Patent Application No. 10-2018-0153767, filed on Dec. 3, 2018, which is hereby incorporated by reference as if fully set forth herein.

### BACKGROUND

### Field of the Invention

The present invention relates to a vehicle having an electric motor and a driving control method for the same, and more particularly to a vehicle that adjusts a regenerative braking amount in response to shifting of the vehicle body weight in the lateral direction and a driving control method for the vehicle.

### Discussion of the Related Art

“Coasting” refers to the state in which a vehicle is driven using inertial energy without outputting driving power. In general, a coasting event is defined as the time during which neither the accelerator pedal (APS) nor the brake pedal (BPS) is operated. The torque applied to the driving shaft during coasting may be referred to as coasting torque. In a general internal combustion engine vehicle, when neither the accelerator pedal nor the brake pedal is depressed, idle torque of the engine is transmitted to the driving shaft by the torque converter and the transmission. This is referred to as “creep torque”.

During coasting, while the creep torque is transmitted from the engine to the driving shaft, the travel load caused by the vehicle speed acts in the direction opposite the direction in which the creep torque is transmitted. The coasting torque is determined as the sum of the travel load and the creep torque. This will be described below with reference to FIG. 1. FIG. 1 is a view showing an example of the relationship between the coasting torque and the vehicle speed while a general vehicle is coasting according to the related art.

Referring to FIG. 1, when the vehicle speed is low, the transmission is generally in a low gear stage. When the speed of the input shaft of the transmission is less than the idle revolutions per minute (RPM) of the engine, the idle torque of the engine is transmitted to the driving shaft. Thus, the vehicle is driven forwards by the creep torque. When the vehicle speed is high, the transmission is in a relatively high gear stage. When the speed of the input shaft of the transmission becomes greater than the idle RPM of the engine, drag caused by cutting fuel to the engine is transmitted to the driving shaft, and thus coasting torque is generated.

Recently, with increased demand for environmentally friendly vehicles, hybrid electric vehicles (HEVs) and electric vehicles (EVs), which use an electric motor as a driving source, have been developed. Since a vehicle equipped with an electric motor has no engine or since the engine thereof is not always operated, creep torque is not generated by the engine. However, to realize the characteristics of a general internal combustion engine vehicle, a vehicle equipped with an electric motor is generally operated such that the electric motor is driven to generate creep torque.

Thus, similar to the phenomenon shown in FIG. 1, in the vehicle equipped with an electric motor, torque in the forward direction, which is caused by the idle RPM of an internal combustion engine and the torque multiplication operation of a torque converter, is simulated in a low-speed state, and torque in the reverse direction, which is caused by the drag formed by cutting fuel to the engine, is simulated in a high-speed state. The region in which the torque in the forward direction is simulated may be referred to as a creep region, and the region in which the torque in the reverse direction is simulated may be referred to as a coasting region. At this time, the torque in the reverse direction may be implemented by regenerative braking.

When a vehicle having an electric motor as a power source, such as a hybrid electric vehicle (HEV) or an electric vehicle (EV), performs a braking operation, the motor is operated as a generator simultaneously with the operation of a conventional hydraulic friction brake, and thus the kinetic energy of the vehicle is converted into electrical energy. This type of braking is referred to as regenerative braking. During the braking operation in a hybrid electric vehicle or an electric vehicle, the maximum regenerative braking amount is used for braking to improve fuel efficiency. At this time, the maximum regenerative braking amount is determined by the maximum power of the motor and the state of charge (SOC) of the battery.

In a hybrid electric vehicle or an electric vehicle, other than the case of an in-wheel system, in which electric motors are mounted in the wheels, a differential gear is applied to the driving wheels. To secure smooth cornering, the differential gear distributes driving torque to drive the left and right wheels or the front and rear driving axles at an appropriate number of rotations, or transmits the same amount of torque to each rotary shaft, thereby allowing the left and right wheels to turn at different rates when driving around a corner. In other words, the differential gear simultaneously transmits the same amount of driving torque to the left and right driving wheels even when the left and right driving wheels turn at different rates.

At this time, the magnitude of the driving torque to be transmitted to the wheels is determined by the driving wheel that is on the relatively low-traction road surface. With this feature, in the situation in which the left and right driving wheels are on road surfaces having different traction properties, if a greater amount of driving torque than the frictional force between the wheel and the relatively low-traction road surface is equally applied to the driving wheels, the wheel on the relatively low-traction road surface may spin with no traction, and the wheel on the relatively high-traction road surface may not receive sufficient driving torque.

During the regenerative braking operation, due to the differential gear, the regenerative braking amount is limited by the wheel to which the relatively small amount of braking torque is applied. Thus, when body roll of the vehicle occurs due to an uneven road surface or sudden cornering at a high speed, the grip that one of the wheels has on the road surface may be substantially reduced due to the shifting of the vehicle's body weight in the lateral direction. In particular, in the regenerative braking situation, it is not possible to generate braking torque up to the maximum regenerative braking amount, which is determined by the maximum power of the motor and the state of charge of the battery, due to the characteristics of the differential gear. If the torque equivalent to the maximum regenerative braking amount is applied to the wheels, the wheel on the relatively low-traction road surface may slip, and thus the requested total braking torque is not provided.

In addition, during wheel slippage, all regenerative-braking-related control is stopped for safe driving, and an electronic stability control system such as a vehicle dynamic control (VDC) system or an electronic stability program (ESP) system is activated. In other words, control for satisfying the requested coasting torque or the requested braking torque is not performed, but control for preventing wheel slippage is performed, which leads to a feeling of poor drivability. In particular, when a high-stage coast torque boosting function is turned on in a vehicle that provides a function of adjusting coasting torque in stages through paddle shift or in a vehicle that provides a function of adjusting acceleration and deceleration using a single pedal, obviating a separate brake pedal, a substantial amount of braking force is generated using regenerating braking during coasting without operating the brake pedal. Thus, during wheel slippage during regenerating braking, a delay occurs in the process of stopping the regenerating braking and performing hydraulic braking to implement the ABS function. Moreover, even when the driver does not engage the brake pedal, the ABS function is implemented, which deteriorates the driving sensation experienced by the driver.

### SUMMARY

Accordingly, the present invention is directed to a vehicle having an electric motor and a driving control method for the same that substantially obviate one or more problems due to the limitations and disadvantages of the related art. An object of the present invention is to provide a vehicle having an electric motor, which may prevent wheel slippage due to regenerative braking even when shifting of the vehicle body weight in the lateral direction occurs, and a driving control method for the vehicle.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In accordance with an aspect of the present invention, the above and other objects may be accomplished by the provision of a method of adjusting regenerative braking torque of a motor of a vehicle configured to transmit power of the motor to opposite side wheels via a differential gear, the method may include determining whether a curved road is present ahead of the vehicle, in response to detecting the curved road, determining the load to be applied to an inner wheel of the opposite side wheels based on lateral weight shifting on the curved road based on at least one of the curvature of the curved road or the vehicle speed, determining a grip of the inner wheel based on the determined load, and correcting a regenerative braking limit based on the determined grip.

In accordance with another aspect of the present invention, a vehicle may include a motor configured to transmit power to opposite side wheels via a differential gear, and a controller configured to determine regenerative braking torque of the motor. The controller may include a first calculation unit configured to, in response to determining through a navigation system that a curved road is present ahead of the vehicle, determine a load to be applied to an inner wheel of the opposite side wheels based on lateral weight shifting on the curved road based on at least one of the curvature of the curved road or the vehicle speed, and a second calculation unit configured to determine a grip of the inner wheel based on the determined load and to correct a regenerative braking limit based on the determined grip.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a view showing an example of the relationship between coasting torque and a vehicle speed while a general vehicle is coasting according to the related art;

FIG. 2 is a block diagram showing an example of the construction of a vehicle for implementing regenerative braking torque control of a motor according to an exemplary embodiment of the present invention;

FIG. 3 is a view showing the basic premise of physical force acting in the situation in which the regenerative braking torque control of the motor according to the exemplary embodiment of the present invention is implemented;

FIG. 4 is a view showing the physical force acting in a curved road environment in which the regenerative braking torque control of the motor according to the exemplary embodiment of the present invention is implemented;

FIG. 5 is a view showing curvature information correction in the regenerative braking torque control of the motor according to the exemplary embodiment of the present invention;

FIG. 6 is a view showing correction in consideration of the inclination of a curved road in the regenerative braking torque control of the motor according to the exemplary embodiment of the present invention;

FIG. 7 is a flowchart showing an example of the process of controlling the regenerative braking torque according to the exemplary embodiment of the present invention; and

FIG. 8 is a view showing the characteristics and effects of the regenerative braking torque control of the motor according to the exemplary embodiment of the present invention through comparison with a comparative example.

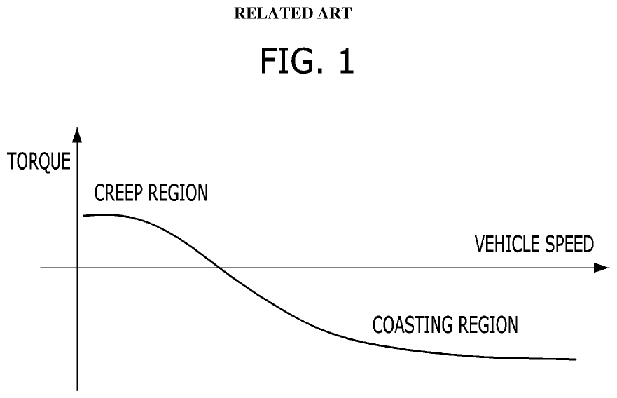

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings so as for those skilled in the art to easily carry out the embodiments. The present invention may, however, be embodied in many different forms, and should not be construed as being limited to the exemplary embodiments set forth herein. In the drawings, parts irrelevant to the description of the present invention will be omitted for clarity. Like reference numerals refer to like elements throughout the specification. In addition, the same reference numerals used throughout the specification refer to the same constituent elements.

The present invention provides a vehicle having an electric motor, which is capable of predicting shifting of the vehicle body weight in the lateral direction in advance and adjusting regenerative braking torque in response to the grip of a wheel on the road, to which a relatively small amount of load is applied.

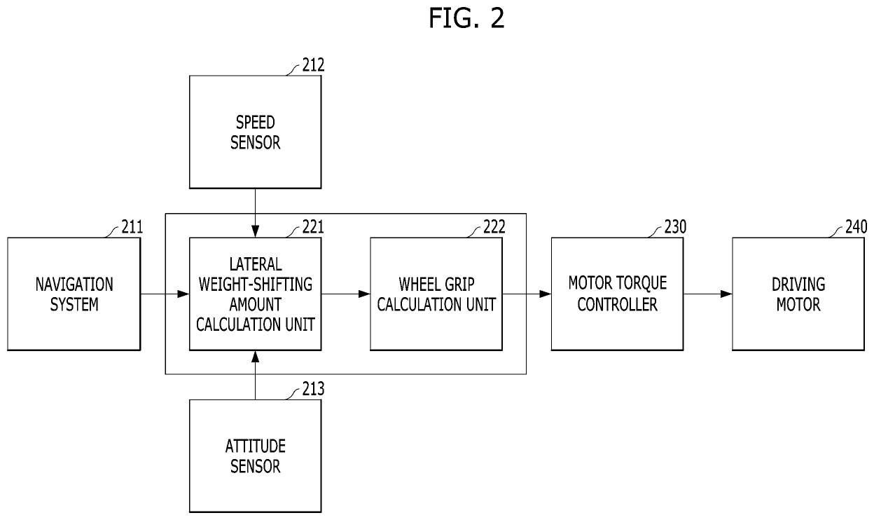

FIG. 2 is a block diagram showing an example of the construction of a vehicle for implementing regenerative braking torque control of a motor according to an exemplary embodiment of the present invention. Referring to FIG. 2, a vehicle that performs regenerative braking torque control according to the exemplary embodiment may include a road information acquisition unit 211, vehicle information acquisition units 212 and 213, a regenerative braking torque controller 220, a motor torque controller 230, and a driving motor 240. These components may all be operated by a vehicle controller.

In particular, above components of the vehicle are components necessary for regenerative braking torque control of the electric motor. Needless to say, a greater number of components than the above components may be included in an actual vehicle as needed.

The navigation system 211 may be configured to transmit information regarding the presence or absence of a curved road in the path ahead and, if present, information regarding the curvature of the curved road to the regenerative braking torque controller 220. Particularly, the navigation system 211 is an example of the road information acquisition unit. In the vehicle according to the exemplary embodiment, the navigation system 211 may include a wireless communication module such as a telematics module configured to acquire information regarding the curvature of the road ahead.

The speed sensor 212 may be configured to transmit current vehicle speed information to the regenerative braking torque controller 220. Depending on the exemplary embodiment, the speed sensor 212 may include another controller configured to acquire vehicle speed information. For example, the speed sensor 212 may include an engine management system (EMS).

The attitude sensor 213 may be configured to sense a lateral inclination of the vehicle, that is, a roll angle of the vehicle, and transmit the sensed information to the regenerative braking torque controller 220. Accordingly, the attitude sensor 213 may include at least one of a gyro sensor, a roll sensor, or an acceleration sensor.

The regenerative braking torque controller 220 may include a lateral weight-shifting amount calculation unit 221 and a wheel grip calculation unit 222. The lateral weight-shifting amount calculation unit 221 may be configured to calculate the amount of lateral weight shifting that will occur when the vehicle is being driven on the curved road ahead, based on the road information and the vehicle information, including the information regarding the curvature of the curved road ahead acquired from the navigation system 211, the vehicle speed information acquired from the speed sensor 212, and the roll angle information acquired from the attitude sensor 213. The wheel grip calculation unit 222 may be configured to calculate the grip of each wheel, to which the motor transmits regenerative braking torque via a differential gear, based on the amount of lateral weight shifting calculated by the lateral weight-shifting amount calculation unit 221, and may be configured to determine the regenerative braking torque in consideration of a smallest grip of one of the wheels. The wheel grip calculation unit 222 may be configured to transmit a torque command that corresponds to the determined regenerative braking torque to the motor torque controller 230.

For an electric vehicle (EV), the regenerative braking torque controller 220 may be a vehicle control unit (VCU). For a hybrid electric vehicle (HEV), the regenerative braking torque controller 220 may be a hybrid control unit (HCU). However, the present invention is not limited thereto. The regenerative braking torque controller 220 is not limited to any specific name or type, so long as it serves as a higher-level controller of the motor torque controller 250 configured to operate a driving motor 240 and configured to determine the regenerative braking torque. In particular, the motor torque controller 230 may be configured to operate the driving motor 240 to implement the regenerative braking torque that corresponds to the torque command. For example, the motor torque controller 230 may be a motor control unit (MCU).

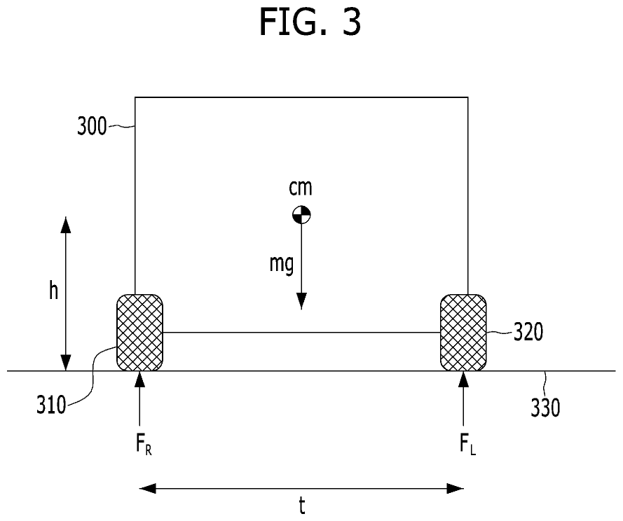

Hereinafter, the calculation process that the regenerative braking torque controller 220 according to the exemplary embodiment performs to adjust the regenerative braking torque based on the information input thereto will be described in detail with reference to FIGS. 3 to 6. FIG. 3 is a view showing the basic premise of physical force acting in the situation in which the regenerative braking torque control of the motor according to the exemplary embodiment is implemented.

The basic physical parameters to be used in the following description are shown in FIG. 3. The vehicle 300 includes a left wheel 310 and a right wheel 320. In particular, the distinction between the front and rear wheels is omitted, and the two wheels shown in FIG. 3 are connected to the motor via the differential gear. The vehicle 300 has a mass m and a center of gravity cm at a height h from the flat road surface 330. The height h of the center of gravity cm may be a value set in advance, or may be estimated by the regenerative braking torque controller 220 based on the state of the vehicle. The two wheels 310 and 320 are spaced apart from each other in the lateral direction by a distance t, namely a wheel track, which is one factor of the specification of the vehicle. The load F_{R} is applied to the left wheel 310, and the load F_{L} is applied to the right wheel 320. If the weight of the vehicle 300 is equally distributed to the left and right sides of the vehicle, the load F_{R} and the load F_{L} have the same magnitude in a flat road environment.

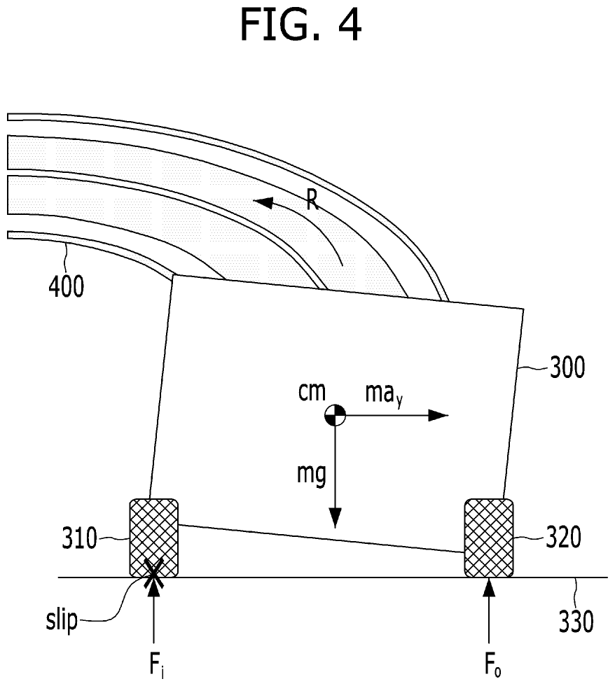

The basic premise in FIG. 3 is changed as shown in FIG. 4 when the road surface 330 is changed to a curved road during operation of the vehicle. FIG. 4 is a view showing the physical force acting in a curved road environment in which the regenerative braking torque control of the motor according to the exemplary embodiment is implemented.

Referring to FIG. 4, when the vehicle is being driven on a curved road 400, which is curved to the left with respect to the straight traveling direction and has a curvature R, lateral acceleration a_{y} acts on the vehicle 300, and thus lateral moment M_{y} and centrifugal force ma_{y} are generated. In particular, it is desirable that the curvature R of the curved road 400 be the minimum curvature thereof, rather than the average curvature thereof to prevent the driving control process from being affected by the driving lane, even when the curved road 400 is a multi-lane road.

When the vehicle travels on a curved road that is curved to the left, a roll angle of the vehicle body becomes nonzero, and weight shifting to the right occurs. Thus, the load Fₒ that is applied to the right wheel 320, which corresponds to the outer side of the curved road 400, is greater than the load Fᵢ that is applied to the left wheel 310, which corresponds to the inner side of the curved road 400. In this state, when a greater amount of regenerative braking torque than the grip of the left wheel 310, which is generated by the load Fᵢ applied thereto, is applied to the left wheel 310, the left wheel 310 may slip (or spin). To prevent this situation, the regenerative braking torque controller 220 may be configured to adjust the regenerative braking torque to fall within the grip of the wheel located at the inner side of the curved road, i.e. the left wheel 310, before the vehicle enters the curved road 400.

First, the lateral weight-shifting amount calculation unit 221 may be configured to calculate the load Fᵢ applied to the inner wheel, i.e. the left wheel 310. The centrifugal acceleration a_{y} generated by the lateral acceleration of the vehicle is equal to “V²/R (∵R »t)” based on the circular motion equation, assuming uniform circular motion. The load Fᵢ applied to the inner wheel may be calculated using the following Equation 1 and Equation 2. The sum of the lateral momentums in the uniform circular motion is zero, which is expressed using the following Equation 1.

$$\sum {M}_{y} = h \cdot {ma}_{y} + {tF}_{i} - \frac{t}{2} mg = 0 \qquad Equation 1$$

If Equation 1 is rearranged with respect to Fᵢ, this may be expressed using the following Equation 2.

$$∴ {F}_{i} = \frac{1}{2} mg - \frac{h}{t} {ma}_{y} = m ( \frac{g}{2} - \frac{{hV}^{2}}{tR} ) \qquad Equation 4$$

If Fᵢ is obtained using Equation 2, the wheel grip calculation unit 222 may be configured to determine the regenerative braking force based on Fᵢ since the regenerative braking force limit, which is calculated through a general control logic based on the maximum output of the motor and the SOC of the battery, does not take into consideration shifting of the vehicle's body weight due to cornering, and thus the inner wheel may not generate as much braking force as the regenerative braking limit.

Therefore, the wheel grip calculation unit 222 may be configured to compare the regenerative braking limit torque (i.e. the maximum regenerative braking torque), which is calculated based on the motor and the SOC of the battery, with the braking limit μFᵢ, which is calculated in consideration of the shifting of the vehicle's body weight, and correct the regenerative braking limit as the minimum value of the comparison result. In particular, μ is a frictional coefficient between the road surface and the tire, which may be a fixed value for each road type or may be determined by an anti-lock braking system (ABS) controller.

The calculation of the regenerative braking limit torque based on the motor and the SOC of the battery is a general function of a hybrid control unit (HCU) or a vehicle control unit (VCU), and thus a detailed description thereof will be omitted. The regenerative braking limit corrected as described above may be expressed using the following Equation 3.

F_{regen limit,new}=min(F_{regen limit}, μFᵢ) (Equation 3)

In Equation 3, F_{regen limit,new} represents the corrected regenerative braking limit, F_{regen limit} represents the regenerative braking limit calculated based on the motor and the SOC of the battery, and μFᵢ represents the grip of the inner wheel generated by the load applied to the inner wheel.

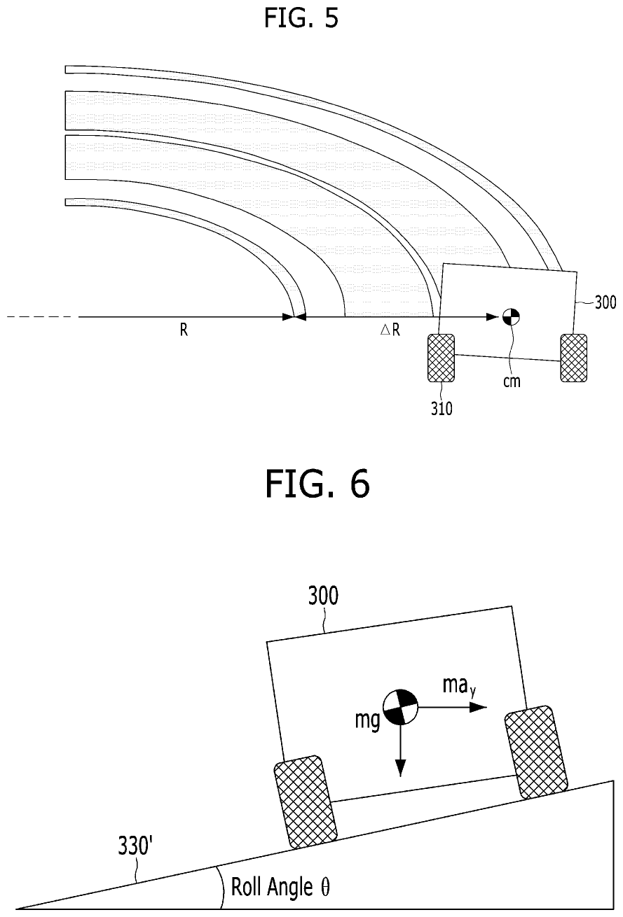

After the vehicle enters the curved road, the lateral weight-shifting amount calculation unit 221 may be configured to correct the load Fᵢ applied to the inner wheel based on the difference in speed between the left wheel and the right wheel. This correction may be performed in real time. This will be described below with reference to FIG. 5.

FIG. 5 is a view showing the curvature information correction in the regenerative braking torque control of the motor according to the exemplary embodiment of the present invention. Referring to FIG. 5, the curvature that is substantially applied to the inner wheel during traveling or driving on the curved road is R+ΔR. Therefore, the lateral weight-shifting amount calculation unit 221 may be configured to calculate the load Fᵢ that is applied to the inner wheel by replacing R in Equation 2 with R+ΔR. In particular, R+ΔR may be calculated using the following Equation 4.

$$\frac{{V}_{RL}}{{V}_{RR}} = \frac{R + Δ R + \frac{t}{2}}{R + Δ R - \frac{t}{2}} \qquad Equation 4$$

In Equation 4, t represents the wheel track, V_{RL} represents the speed of the left wheel, and V_{RR} represents the speed of the right wheel. Here, since V_{RL} and V_{RR} may be obtained through the speed sensor (or the wheel speed sensor) and t is a fixed value as one factor of the specification of the vehicle, it may be possible to calculate R+ΔR.

In addition to the above-described curvature correction, the lateral weight-shifting amount calculation unit 221 may also be configured to perform correction in consideration of the inclination of the curved road 400. This will be described below with reference to FIG. 6.

FIG. 6 is a view showing the correction in consideration of the inclination of the curved road in the regenerative braking torque control of the motor according to the exemplary embodiment of the present invention. Referring to FIG. 6, a curved road is generally designed such that the outer side thereof is higher than the inner side thereof in consideration of centrifugal force. Therefore, the lateral weight-shifting amount calculation unit 221 may replace mg in Equation 2 with mgcosθ and replace ma_{y} in Equation 2 with ma_{y}cosθ using the roll angle measured by the sensor 213.

In summary, the lateral weight-shifting amount calculation unit 221 may be configured to calculate Fᵢ using Equation 2 before the vehicle enters the curved road, and calculate Fᵢ by applying the correction factors, described above with reference to FIGS. 5 and 6, to Equation 2 after the vehicle enters the curved road.

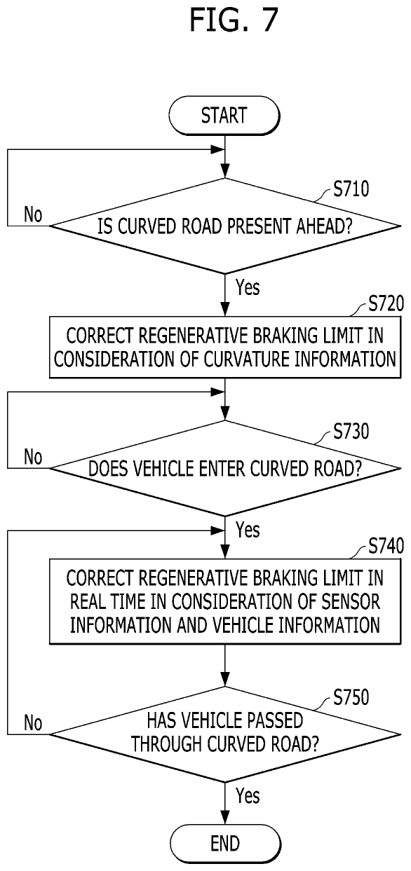

The above-described process of adjusting the regenerative braking torque will now be described in more detail with reference to FIG. 7. FIG. 7 is a flowchart showing an example of the process of controlling the regenerative braking torque according to the exemplary embodiment of the present invention.

Referring to FIG. 7, the navigation system 211 may be configured to determine whether a curved road is present ahead of the vehicle (S710). When a curved road is present ahead of the vehicle, the lateral weight-shifting amount calculation unit 221 may be configured to calculate the load that is applied to the inner wheel based on the curvature information and the vehicle speed information, and the wheel grip calculation unit 222 may be configured to correct the regenerative braking limit by calculating the grip of the wheel based on the calculated load (S720). Since the correction of the regenerative braking limit is the same as described above with reference to Equations 2 and 3, a duplicate description thereof will be omitted.

When the vehicle is being driven according to the corrected regenerative braking limit and the vehicle enters the curved road (YES in S730), the regenerative braking limit may be corrected in real time based on the sensor information (i.e. the roll angle) and the vehicle information (i.e. the wheel speed of each wheel) (S740). Since the real-time correction is the same as described above with reference to FIGS. 5 and 6, a duplicate description thereof will be omitted. Thereafter, when the vehicle has passed through the curved road (YES in S750), the regenerative torque control according to the exemplary embodiment may terminate.

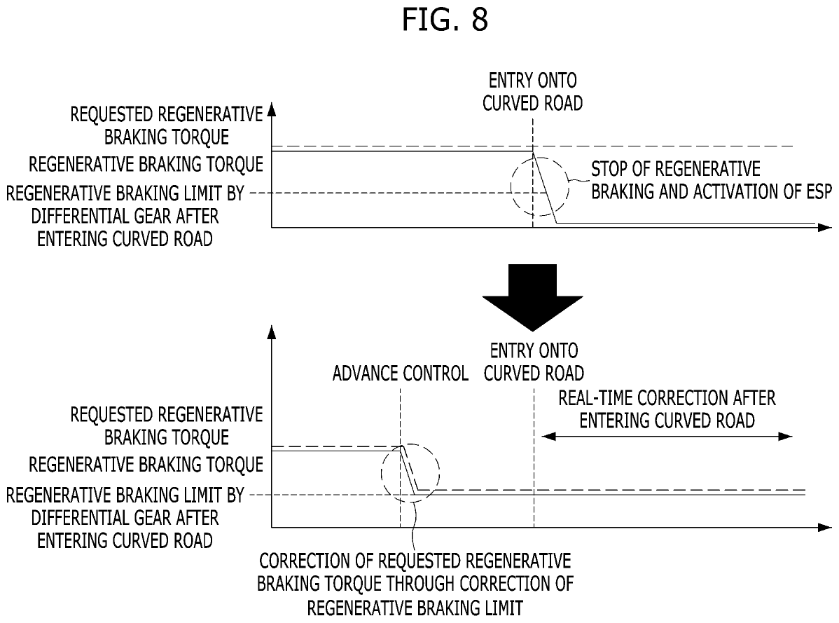

Hereinafter, the characteristics and effects of the driving control method according to the exemplary embodiment will be described with reference to FIG. 8. FIG. 8 is a view showing the characteristics and effects of the regenerative braking torque control of the motor according to the exemplary embodiment of the present invention through comparison with a comparative example.

The upper graph in FIG. 8 shows the regenerative braking torque of the motor with respect to the requested regenerative braking torque when the vehicle is being driven on a curved road according to general regenerative braking torque control, and the lower graph in FIG. 8 shows the regenerative braking torque of the motor with respect to the requested regenerative braking torque when the vehicle is being driven on a curved road according to regenerative braking torque correction control of the exemplary embodiment of the present invention. In each of the upper and lower graphs in FIG. 8, the horizontal axis represents a traveling distance, and the vertical axis represents torque.

Referring to the upper graph in FIG. 8, when the vehicle enters a curved vehicle, although the regenerative braking torque control is performed based on the motor and the SOC of the battery, the requested regenerative braking torque, which is a control target, is maintained constant since the general regenerative braking torque determination factors such as the motor and the SOC of the battery are not changed. However, when the vehicle enters a curved road, body roll of the vehicle occurs due to centrifugal force, and the load that is applied to the inner wheel is decreased. In this state, when the requested regenerative braking torque is greater than the grip of the inner wheel, which is generated by the load applied thereto, the inner wheel may slip due to a limitation caused by equal torque distribution of the differential gear. Thus, the regenerative braking is stopped, and the ESP system (or the VDC system) is activated. As a result, the requested regenerative braking torque is not provided, and drivability is deteriorated.

On the other hand, as shown in the lower graph in FIG. 8, when the control according to the exemplary embodiment of the present invention is performed, before the vehicle enters a curved road, the load to be applied to the inner wheel on the curved road may be estimated based on the curvature of the curved road and the vehicle speed, and the requested regenerative braking torque may be corrected in advance based on the estimation result, thereby preventing wheel slippage after entering the curved road. In addition, since the requested regenerative braking torque may be corrected in real time after the vehicle enters the curved road, it may be possible to ensure stable driving and to continuously maintain the regenerative braking until the vehicle completely passes through the curved road, thereby improving fuel efficiency.

In the above exemplary embodiment, although the control process in which the regenerative braking limit may be corrected based on shifting of the vehicle's body weight in the lateral direction has been described by way of example, the weight-shifting direction used for the correction of the regenerative braking limit according to the present invention is not limited to a specific direction. For example, according to another exemplary embodiment of the present invention, the regenerative braking limit may be corrected in consideration of shifting of the vehicle's body weight in the longitudinal direction due to the inclination of a road or acceleration/deceleration as well as shifting of the vehicle's body weight in the lateral direction. In particular, the amount of weight shifting due to acceleration/deceleration may vary based on whether the wheels connected with the motor are the front wheels or the rear wheels. As a result, the correction process according to the present invention is capable of increasing the driving stability of the vehicle.

The present invention described above may be implemented as a computer-readable code of a non-transitory computer-readable medium in which programs are recorded. The non-transitory computer-readable medium includes all kinds of recording devices in which data that may be read by a computer system is stored. Examples of the non-transitory computer-readable medium may include a hard disk drive (HDD), a solid-state disk (SSD), a silicon disk drive (SDD), ROM, RAM, a CD-ROM, a magnetic tape, a floppy disk, and an optical data storage device.

As is apparent from the above description, according to the vehicle related to at least one exemplary embodiment of the present invention constructed as described above, regenerative braking control may be performed more efficiently. In particular, the vehicle having an electric motor according to the present invention may be configured to estimate lateral weight shifting in advance and adjust a regenerative braking amount based on the estimation result, thereby preventing wheel slippage during lateral weight shifting and consequently improving drivability and driving efficiency.

It will be appreciated by those skilled in the art that the effects achievable through the present invention are not limited to those that have been specifically described hereinabove, and other effects of the present invention will be more clearly understood from the detailed description above.

Accordingly, the detailed description above is not intended to be construed to limit the present invention in all aspects, but is to be considered by way of example. The scope of the present invention should be determined by reasonable interpretation of the accompanying claims, and all equivalent modifications made without departing from the scope of the present invention should be included in the following claims.

What is claimed is:

1. A method of controlling regenerative braking torque of a motor of a vehicle configured to transmit power of the motor to opposite side wheels via a differential gear, the method comprising:
determining, by a controller, whether a curved road is present ahead of the vehicle;
in response to detecting that the curved road is present, determining, by the controller, a load to be applied to an inner wheel of the opposite side wheels depending on lateral weight shifting on the curved road based on at least one of a curvature of the curved road or a vehicle speed;
determining, by the controller, a grip of the inner wheel based on the determined load; and
correcting, by the controller, a regenerative braking limit based on the determined grip.

2. The method according to claim 1, wherein the correcting is performed before the vehicle enters the curved road.

3. The method according to claim 1, wherein the determining the grip includes:
multiplying, by the controller, the determined load by a frictional coefficient between a tire and a road surface.

4. The method according to claim 1, wherein the correcting includes:
determining, by the controller, a first regenerative braking torque based on the motor and a state of charge of a battery; and
determining, by the controller, a second regenerative braking torque, equivalent to a smaller value of the grip and the first regenerative braking torque, as the regenerative braking limit.

5. The method according to claim 1, further comprising:
determining, by the controller, whether the vehicle has entered the curved road; and
in response to determining that the vehicle has entered the curved road, re-correcting, by the controller, the regenerative braking limit based on at least one of roll angle information or a speed of each of the opposite side wheels.

6. The method according to claim 5, wherein the re-correcting is performed in real time while the vehicle is being driven on the curved road.

7. The method according to claim 1, wherein the curvature includes a minimum curvature of the curved road.

8. A non-statutory computer-readable recording medium having recorded therein a program for causing a computer to execute the method of controlling regenerative braking torque described in claim 1.

9. A vehicle, comprising:
a motor configured to transmit power to opposite side wheels via a differential gear; and
a controller configured to determine regenerative braking torque of the motor,
wherein the controller includes:
a first calculation unit configured to, in response to determining through a navigation system that a curved road is present ahead of the vehicle, determine a load to be applied to an inner wheel of the opposite side wheels depending on lateral weight shifting on the curved road based on at least one of a curvature of the curved road or a vehicle speed; and
a second calculation unit configured to determine a grip of the inner wheel based on the determined load and to correct a regenerative braking limit based on the determined grip.

10. The vehicle according to claim 9, wherein the second calculation unit is configured to correct the regenerative braking limit before the vehicle enters the curved road.

11. The vehicle according to claim 9, wherein the second calculation unit is configured to determine the grip by multiplying the determined load by a frictional coefficient between a tire and a road surface.

12. The vehicle according to claim 9, wherein the second calculation unit is configured to:
compare a first regenerative braking torque, determined based on the motor and a state of charge of a battery, with the grip; and
determine a second regenerative braking torque, equivalent to a smaller value of a comparison result, as the regenerative braking limit.

13. The vehicle according to claim 9, wherein, when the vehicle enters the curved road, the first calculation unit is configured to correct a load to be applied to the inner wheel based on at least one of roll angle information or a speed of each of the opposite side wheels, and the second calculation unit is configured to re-correct the regenerative braking limit based on the corrected load.

14. The vehicle according to claim 13, wherein the first calculation unit is configured to correct the load in real time while the vehicle is being driven on the curved road.

15. The vehicle according to claim 9, wherein the curvature includes a minimum curvature of the curved road.
